(19) United States
(12) Patent Application Publication
(10) Pub. No.: US 2026/0054902 A1
(43) Pub. Date: Feb. 26, 2026

(54) CONTAINER PALLET, MODULE AND RACK AND RELATED METHODS

(71) Applicant: COG CONTAINERS LTD, Malvern, Worcestershire (GB)

(72) Inventor: Iain McGuffie, Malvern, Worcestershire (GB)

(21) Appl. No.: 19/106,484

(22) PCT Filed: Aug. 29, 2023
(86) PCT No.: PCT/GB2023/052221

§ 371 Date: Feb. 25, 2025

(30) Foreign Application Priority Data
Aug. 31, 2022 (GB) 2212668.4

(51) Int. Cl. B65D 71/70; B65D 19/44; B65D 21/02; B65D 71/00; B65D 85/68

(52) U.S. Cl. CPC B65D 71/70; B65D 19/44; B65D 21/0202; B65D 71/0088; B65D 85/68; B65D 2519/00815; B65D 2585/88

(57) ABSTRACT

A container pallet (10) is provided which includes a lattice of walled cells (12) for supporting a plurality of tessellatable containers in a close packed arrangement. Each walled cell (12) has a profile of a polygon that is tessellatable with itself or one or more other polygons and each walled cell (12) comprises a lower side wall (16). An upper side wall (14) may be provided in each walled cell and inset from the lower side wall, and/or a retaining lip may be provided around some or all of the periphery the container pallet. The container pallet may be modular.

The present invention relates to a container pallet or battery cell framework for receiving and/or supporting of a plurality of tessellated containers, such as to facilitate transport of the containers; a container pallet module or battery cell framework module; a rack for a plurality of containers in a tessellated or pseudo-tessellated arrangement; a method of packing or securing tessellatable containers using at least two container pallets or battery cell frameworks; a method of assembling a container pallet or battery cell framework for a plurality of tessellated containers; and a method of container management using a rack of containers.

### BACKGROUND TO THE INVENTION

A conventional pallet is made from planks or slats of wood which are typically nailed or screwed together. The wood is often low quality or scrap, and may cause a splinter if touched or gripped. If a pallet is damaged or becomes worn out then it can be replaced at low cost.

Industrial products such as liquids are frequently supplied in containers which are often transported on pallets. The containers can be stacked on top of each other to maximise the number of containers transported on a single pallet.

The number of layers of stacked containers is limited because of the inherent instability containers on a pallet. In a conventional pallet system, the containers are unstable and could fall off the pallet if the pallet is tipped at an angle.

The shape of conventional square pallets minimises wasted space when supporting cuboidal boxes of products. However, in cases where the containers have other shapes, a conventional square pallet does not resemble the shape of the load it is carrying and so space on the pallet will be wasted.

Wasted space on a pallet also results in wasted space in a warehouse during storage or in a vehicle during transport. That is, where a portion of a pallet is not being used, the pallet is still occupying space in the warehouse or vehicle, and the number or amount of goods that can be stored and transported is sub-optimal.

Goods are often stacked on a pallet in multiple layers. Full pallets of stacked containers may be wrapped in plastic, e.g. polythene sheeting, to secure the containers and reduce the risk of collapse. However, a large quantity of single-use plastic packing material is required, generating large amounts of waste, and the height of the stacking is still limited due to instability. This instability is often apparent if the containers are stacked high and filled with heavy goods such as paint or other dense liquid, and instability is worse for higher layers of containers.

One solution for palletised transport and/or storage of fluids is to use large, reusable containers such as intermediate bulk containers (IBCs) which may contain 1000 litres or more. However, these require liquid to be transported in large quantities which is not always feasible or economically viable.

A further issue is that warehouses and retailers often require stock to be rotated, to ensure older goods are transported, sold or otherwise dispensed prior to newer stock. This is important for stock that has a shelf-life or must be sold at certain times (e.g. seasonal stock).

Containers or stock are typically rotated by moving older containers/stock out of the way on a shelf, manually putting newer goods at the back of the shelf, and then moving the older goods back into position in front of the newer goods. Rotation tends to happen this way because access to the rear of the shelf is often not available, e.g. if the shelf is closed off or backed onto a wall. This encourages the older containers/stock to be taken from the front of the shelving because they are easier to access, and the newer goods can later be brought forward. Nonetheless, this requires manual intervention and can be time consuming. If containers/stock is not rotated, this can lead to older goods being thrown away if expired, increasing costs associated with waste.

The stock rotation process can be impacted by a single mistake. Stock is therefore monitored during “stock-takes” often performed at periodic intervals to check for older stock among other things. Stock-taking is even more laborious however, and can result in warehouse or store downtime.

Another problem in respect of containers on a smaller scale relates to batteries. Modern batteries often contain a plurality of battery cells which may be stored in battery modules. Each battery cell degrades over time as it is depleted and recharged. Draining a battery below a particular charge level, e.g. below 20%, can permanently damage some of the battery cells, resulting in a lower charge storage capacity thereafter.

A battery therefore typically needs to be replaced after a certain number of charge cycles because it holds less total charge and requires recharging more often. Individual battery cells within the battery may degrade at different rates, so in a given battery which is replaced, there may be some battery cells which are still functioning well.

Modern electronic devices such as smartphones, tablets and laptops are frequently provided with built-in batteries that are inaccessible (or very difficult to access) for the consumer, so when the battery ‘dies’, i.e. no longer holds charge long enough for the consumer's liking or needs, the entire device may end up being replaced. This is inconvenient, expensive and often wasteful.

Batteries for larger, more energy-intensive applications such as powering an electric vehicle can be particularly expensive, so replacement is costly whether only the battery is being replaced or the entire vehicle is being replaced. This is because electric vehicle value is in part based on potential driving range, which depends in turn on total charge capacity in the vehicle battery.

It is an object of the present invention to reduce or substantially obviate the aforementioned problems.

### STATEMENT OF INVENTION

According to a first aspect of the present invention, there is provided a container pallet or battery cell framework comprising a lattice of walled cells for receiving and/or supporting a plurality of tessellatable containers in a close packed arrangement, in which each walled cell has a profile of or approximating a polygon that is tessellatable with itself or one or more other polygons and each walled cell includes a lower side wall and an upper side wall, and the upper side wall is inset from the lower side wall in a direction towards a central axis of the aperture.

According to a second aspect of the present invention, there is provided a container pallet or battery cell framework comprising a lattice of walled cells for receiving and/or supporting a plurality of tessellatable containers in a close packed arrangement, in which each walled cell has a profile of or approximating a polygon that is tessellatable with itself or one or more other polygons, and each walled cell includes a container receiving surface and a lower side wall extending away from the container receiving surface, the aperture having a central axis, and at least one retaining lip is provided around a periphery of the container pallet.

The container pallet provides a means to stably transport and/or store tessellated containers, optionally stacked in multiple layers, thereby maximising use of available space in the location where the containers are being transported or kept.

The pallet of the first aspect has upper walls for each walled cell which facilitate location of respective containers on the pallet. The pallet of the second aspect has a peripheral upper wall or retaining lip which helps retain the tessellated containers in position as a group on the pallet. It will be appreciated that these are different ways of addressing similar issues and both features may be provided in some embodiments. The pallet of the second aspect may be used when a fixed or known number of containers needs to be transported or stored, and/or when the configuration (i.e. size) of the pallet does not need to be customised.

The pallet can be considered as entirely reusable. There is no need for containers to be shrink-wrapped, cling-wrapped or stretch-film wrapped (or similar) onto the pallet.

The container pallet thus provides a more environmentally-friendly packing solution which avoids the need for single-use packing.

The term ‘container pallet’ may be considered to mean a portable platform on which containers can be placed for storage or transport.

The term ‘battery cell framework’ may be considered to mean a framework or grid (or other repeating lattice) suitable for populating with a plurality of battery cells. The battery cell framework may also be considered as a power cell bay/dock or a battery cell receiving array.

Any feature presented with respect to the container pallet is also disclosed in respect of the battery cell framework, and vice versa.

The term ‘lattice’ refers to a regular and/or repeating arrangement of walled cells in a plane of the container pallet. The lattice may be considered to be a honeycomb, latticework or framework. The walled cells of the lattice may or may not include apertures.

The container pallet or battery cell framework may be considered to provide a three-dimensional pallet surface or battery cell engagement surface for receiving containers in the close-packed arrangement.

The term ‘tessellatable’ may be considered to refer to polygonal shapes which have a 2D profile that can be substantially tessellated or pseudo-tessellated in a plane.

The term ‘close packed arrangement’ is intended to mean that containers on the pallet are provided in a substantially space-efficient arrangement, when viewed along an axis perpendicular to a lateral plane through walled cells of the container pallet. Each pair of container side faces should be substantially in abutment substantially along the length of the containers. However, the close packed arrangement does not require that there is no vacant space at all between adjacent containers. Indeed, there may be interstices, vacancies or voids resulting from the random or periodic absence of individual containers and/or by virtue of the shapes of the containers not being in abutment along their entire lengths.

The term ‘cell’ is used in this specification in two contexts. One is that where the container pallet or battery cell framework includes “walled cells”, and the other is that where each container may be a “battery cell”. This specification endeavors to make clear which of these two meanings applies, but if not explicitly stated in a particular instance then a sensible interpretation of the term cell should be applied based on the context in which it is used.

The term ‘retaining lip’ may be considered to mean a lip which limits or substantially prevents lateral movement of a container relative to the pallet or framework, when the container is positioned on the pallet/framework.

The retaining lip may be provided around the entire periphery of the pallet/framework. A plurality of retaining lips may be provided. The retaining lip(s) may provide a zig-zag type peripheral lip around the pallet. The retaining lip(s) may be planar walls.

The retaining lip(s) and/or the footprint of the pallet may substantially conform to or include parts of the polygonal profiles of the outermost cells of the pallet or framework.

The close packed arrangement of containers may match the lattice of walled cells, with a regular or repeating arrangement of containers.

The lower side wall of each cell may be suitable for fitting around an upper end of a container (preferably a single container).

The lower side wall may extend down from a central plane of the pallet or a plane disposed between the lower and upper side walls.

The upper side wall of each cell may be suitable for fitting around a lower end of a container (preferably a single container).

The upper side wall may extend up from a central plane of the pallet or a plane disposed between the lower and upper side walls.

The container receiving surface may be considered to be an uninterrupted planar surface common to all the cells of the pallet.

The profile of each cell may be considered as a cross-section of the cell when viewed along a central longitudinal axis of the cell, or when viewed along an axis perpendicular to a lateral plane of the container pallet which laterally bisects the cell.

The tessellatable profile of each walled cell may be substantially in the plane of the container pallet.

Each walled cell may include a lateral wall disposed around the upper side wall. The lateral wall may be considered to provide the container receiving surface. The lateral wall may lie in a plane between the upper side wall and the lower side wall.

The profile of the polygon should be construed as meaning the polygonal shape when a cell of the container pallet or battery cell framework is viewed along the central axis of that cell.

Profiles of the lower side wall and upper side wall may be approximately based on the same polygon.

The lower side wall and upper side wall may have different profiles, optionally based on the same general polygonal profile. For example, both the upper and lower side walls may have a generally hexagonal profile, but the actual perimeter of the upper and lower side walls may differ through recesses and/or protrusions being located at different positions on the sides and/or corners.

The recesses and protrusions may be tongue and groove type recesses and protrusions.

The polygon (or profile thereof) may be a regular polygon. The polygon (or profile thereof) may be an irregular polygon. The polygon or profile may be any regular or irregular polygon which tessellates with itself or one or more other regular or irregular polygons.

The profile of the polygon may be selected from the following group: triangular (such as equilateral or isosceles or right-angled triangular), square, rectangular, pentagonal, hexagonal, octagonal, or any tessellating combination of two or more of these regular or irregular polygons. For example, multiple polygonal profiles which tessellate together include triangular and hexagonal profiles, or square and octagonal profiles.

The walled cell approximates the profile of the polygon and may not be exactly the shape of that polygon. The corners may appear rounded and/or include small protrusions or recesses when viewed in profile. The edges may be curved and/or include small protrusions or recesses when viewed in profile. However, the profile of the lower and/or upper side walls may each have the overall form of the relevant polygon.

The lower side wall and (where provided) the upper side wall may define an aperture through the walled cell. The aperture may be substantially the same polygonal shape as the walled cell.

Having large apertures through the cells minimises the weight of the pallet. The lattice arrangement of cells contributes to structural strength of the pallet despite the reduced amount of material in the pallet.

The aperture may include an upper aperture portion and/or a lower aperture portion.

The upper aperture portion may be defined by the upper side wall. The lower aperture portion may be defined by the lower side wall.

The aperture may extend from a top of the upper side wall to a bottom of the lower side wall.

Each walled cell may be considered to be an open cell. That is, the aperture may extend through the cell from one side of the pallet to the other.

Each aperture may have a width which is approximately 65% to 90% of the width of its walled cell. The relative width may be about 70% to 80%, or about 75%.

In the case of a pallet, the width of each aperture may be on the order of centimetres or metres (e.g. about 10 cm to about 1 m). In the case of a battery cell framework, the width of each aperture may be on the order of millimetres (e.g. about 2-3 mm to about 10 mm). However, larger or smaller sizes of apertures may be provided depending on the desired application and these values should not be taken to restrict the size of the device in any way.

Where a walled cell is an apertured cell as discussed above, the polygonal profile of its side wall(s) may be considered to provide the outline of the relevant polygon, when viewed along the longitudinal axis of the cell (that is, perpendicular to the plane of the pallet).

The pallet or framework can include any suitable number of walled cells for receiving a corresponding number of containers. Any suitable integer number of walled cells may be provided. A smaller pallet may have a number of walled cells between 1 and 10 inclusive, for example. A medium-sized pallet may have a number of walled cells between 7 and 24 inclusive, for example. A larger pallet may have 20 or more walled cells, e.g. up to any of 50, 100, 150, 200, 500 or 1000. In some cases, thousands of walled cells (from around 3000 to around 25000 or more, or any thousand increment in that range) may be provided for a battery cell framework for an electric vehicle.

Larger numbers of cells may be provided for a pallet or battery framework as large as an HGV trailer or other portable structure of comparable size. In other words, the size of the device can vary depending on the desired application. The terms small, medium and large are intended to relate to the quantity of containers which can be received, rather than absolute size of the pallet and corresponding containers.

It will be appreciated that the number of walled cells required for a particular application is related to the storage requirements (e.g. for container goods or energy capacity) desired for a particular application, and the pallet/framework may be sized accordingly.

In some embodiments, the container pallet may have a maximum length of about 13.5 metres. In some embodiments, the container pallet may have a maximum width of up to about 2 to 2.5 metres. A minimum width of the container pallet may be about 0.25 metres or 0.5 metres. These dimensions are suitable for fitting into a UK lorry trailer or into a standard shipping container. Larger pallets may of course be used or assembled in warehouses or for other transport or storage use cases. However, larger or smaller sizes may be provided depending on the desired application and these values should not be taken to restrict the size of the device in any way.

The inset or lateral wall may be considered to provide a receiving surface for receiving an end of the container. The receiving surface may receive a protruding rim extending from the end of the container. The lateral extent of the inset may be substantially equal to a width of a protruding rim of a given container, to facilitate close-packing of the containers. The upper side wall and lower side wall may be offset to provide a container receiving surface.

The walled cells of the pallet may be integrally formed. The upper side wall and lower side wall of each cell may be integrally formed. Integrally forming the pallet provides advantages in production. Techniques such as injection moulding may be used to manufacture the pallet as a single piece.

The lateral walls around each upper side wall may form a common surface for receiving containers.

The walled cells may be arranged in a horizontal plane. The lower side walls of the cells may be disposed below the horizontal plane. Where provided, the upper side walls may be disposed above the horizontal plane. This allows all containers forming a single layer of tessellated containers to be provided at the same height as each other.

The polygon is preferably a hexagon or a substantially hexagonal shape. That is, each walled cell preferably has a hexagonal profile or shape (which may be a hexagonal outline, if the cell is apertured).

The container pallet may be substantially planar. The walled cells may be disposed substantially in a common plane.

The upper and/or lower side walls may comprise engagement profiles for complementary engagement with corresponding profiles on each end of the container.

For example, either or both side walls may include longitudinal protrusions or recesses, e.g. at each corner of the polygonal profile, for helping locate the container against the side wall. The container may have a top engagement profile and/or a bottom engagement profile for complementary engagement with the pallet. This can help to provide a better fit between container and pallet for transport and/or storage.

A given container pallet may engage the container(s) only at the lower ends of each container (or only at the upper ends of each container). This may leave the medial portion of each container, i.e. most of the side of the container, unobstructed for ease of labelling and identification (e.g. for display of sell by dates).

Where provided an upper side wall is provided in each walled cell, the upper side wall may be angled inwards towards the central axis of the aperture. Angling the upper side wall towards the central axis of the aperture assists in locating the bottom end (or complementary engagement profile) of the container with the upper side wall and in subsequent removal of the container.

The container pallet may comprise engagement elements for engaging the pallet to one or more adjacent container pallets. The engagement elements may be lateral engagement elements. That is, for lateral connection to an adjacent container pallet.

The engagement elements may allow multiple container pallets to be connected together, for example in a custom configuration. The lower side walls of at least some of the walled cells may comprise the engagement elements.

The engagement elements facilitate easy interconnection between pallets or pallet modules. This allows for custom sizes and shapes of pallets to be assembled as needed for a particular use.

The engagement elements may comprise protrusions and/or recesses on the lower side wall. The protrusions and/or recesses may extend from the bottom to the top of the lower side wall. The protrusions and/or recesses may extend in a direction substantially parallel to the central axis of the cell. The protrusions and recesses in the lower side wall may correspond to protrusions and recesses on the external faces of the containers.

The protrusions and recesses on the external faces of the containers may allow the containers in a layer to interlock, which may increase the stability of each layer when provided on the pallet.

When a plurality of containers are provided on the pallet, the protrusions and/or recesses of the lower side walls of the cells and corresponding protrusions and/or recesses of the containers may be considered to form substantially uninterrupted protrusions and recesses along external faces of a plurality of layers of stacked containers. That is, the protrusions/recesses on the pallet and containers may be vertically aligned.

The walled cells may be arranged in a horizontal plane (or lateral plane). The lower side walls may be disposed below the horizontal plane. Where provided, the upper side walls may be disposed above the horizontal plane.

The periphery of the pallet may be formed by portions of polygonal profiles of the outermost walled cells in the pallet.

Where provided, the retaining lip may extend above and below the horizontal plane of the container pallet.

Two container pallets may be used to sandwich either side of a plurality of tessellated containers. This may hold the containers together in the close-packed arrangement for preventing out-of-plane displacement of a container.

Sandwiching the tessellated containers between container pallets can provide a more stable structure for transportation and storage of the containers, particularly where multiple layers of containers are stacked on top of each other with a container pallet disposed between each layer.

The pallet may be stackable together (or nested together) with other similar pallets for stacking for storage. When stacked together, the upper side walls of the cells of one pallet may nest in the underside of a second pallet. This minimises storage space required for the container pallets when not in use.

A supporting pallet or supporting framework may be provided for supporting the container pallet or battery cell framework. The supporting pallet/framework may be considered to provide a base for spacing the first pallet/framework from the ground or another surface or wall.

The supporting pallet/framework may support a side of the first pallet/framework which is opposite the container-receiving or container-supporting side of that first pallet/framework.

The supporting pallet/framework may be substantially similar to the pallet/framework that it supports, or cover a substantially similar area/footprint. This can allow for space-efficient stacking when storing the pallets/frameworks. It can also ensure that the supported pallet is evenly supported.

Preferably, the supporting pallet/framework is adapted to support undersides of each walled cell of the first pallet/framework.

Preferably, a gap is provided between the supporting pallet/framework and the first (or supported) pallet/framework. The purpose of the gap is to allow the first pallet/framework to be more easily disengaged from the supporting pallet/framework.

For example, the gap may be large enough to accept the forks of a forklift for lifting the supported pallet away from the supporting pallet.

The pallet or framework may be made of plastic, metal, or a composite material.

The container pallet or battery cell framework may include one or more sensors, such as any one or more of: load sensor(s), pressure sensor(s), strain sensor(s), piezoelectric sensor(s). The sensor(s) are intended to sense the weight of a container or containers, which may be the weight of the container(s) above the sensor(s).

The sensor(s) may be provided in any suitable location(s) in the pallet or framework.

The sensor(s) may each be arranged in or adjacent to one of the walled cells. There may be sensors for some or all of the walled cells for corresponding to each container-receiving/supporting area.

This can provide a smart or intelligent pallet/framework. The sensor output(s) can be used to determine which containers are empty, which are full of a product, and which are partially full of a product. Where multiple pallets are stacked on top of each other, for example, the weight of a given column of containers may be inferred.

Where the weight of each container (absent any product in the container) can be treated as a constant, the sensor(s) thus allow for the amount of product in each container or in a pallet of containers to be determined without having to take the containers off the pallet. That is, the sensor(s) help to facilitate stock management and/or control.

The sensor output(s) may also be used to assess whether a given pallet or stack of pallets is overloaded and possibly at risk of collapse, or if the weight distribution of containers on a particular pallet is overly skewed to one side of the pallet and contributing to possible instability in a stack of container pallets and containers, for example.

According to a third aspect of the present invention, there is provided a container pallet module or battery cell framework module for assembly with one or more other modules into a container pallet or battery cell framework, the module comprising a walled cell having a profile of or approximating a polygon that is tessellatable with itself or one or more other polygons, the walled cell including a lower side wall and upper side wall, in which the upper side wall is inset from the lower side wall in a direction towards a central axis of the walled cell, and the module includes side wall connection means for allowing connection of the module to at least one additional module.

Providing individual modules allows the size and shape of a container pallet assembled from the modules to be customised. Where additional containers need to be stored and/or transported, the modular nature of the container pallet allows additional container receiving spaces in each layer to be added. Equally, modules can be detached from the container pallet to minimise its footprint, saving space in a warehouse or transport vehicle.

That is, by providing pallet modules, a pallet can be constructed to be as large or small as necessary, and with a preferred length and width, to accommodate the actual load of containers to be transported or stored. As a result, there is less wasted space in a warehouse or transport vehicle, because the footprint of the pallet does not extend substantially beyond the footprint of the corresponding containers on it during use.

Any feature presented with respect to the first or second aspects of the invention may be provided in the third aspect of the invention.

The lower side wall may define a perimeter or profile perimeter of the module. In other words, the perimeter of the lower side wall may define the footprint of the module.

The lower side wall and upper side wall may together define an aperture through the walled cell. Similar to the preceding aspects of the invention, this minimises module weight.

The side wall connection means may include lateral engagement elements, preferably on the lower side wall, for engagement to one or more other modules and/or to one or more container pallets or battery cell frameworks (whether modular or not). The engagement elements may be lateral engagement elements. The engagement elements may include similar features to those presented with respect to the first and second aspects of the invention.

The container pallet modules may be connected together in a tessellated arrangement or lattice to form a modular container pallet for supporting a plurality of tessellatable containers in a close packed arrangement.

The modular container pallet may comprise any feature or combination of features of the first and second aspects of the invention.

The container pallet may be assembled from modules by providing a plurality of container pallet modules and connecting the container pallet modules together using their side wall connection means.

The side wall connection means may include an aperture for receiving a fastening means (preferably releasable fastening means). The fastening means may be provided separately as a discrete item, or may be part of the module.

One or more pallet foot/feet may be provided on (or detachably connected to) the module or pallet of any of the first, second or third aspects of the present invention.

The foot/feet may be provided on the lower side wall(s) of the module or pallet. The foot or plurality of feet may extend downwards from the lower side wall for supporting the module or pallet in a raised position spaced from an adjacent surface or the ground.

Providing a foot or feet raises the pallet from the ground, e.g. to provide space for a forklift's tines to be inserted underneath the pallet. It may also be preferred to raise products off the floor to mitigate water damage in the event of flooding and to facilitate cleaning, for example.

According to a fourth aspect of the present invention, there is provided a method of packing or securing a plurality of tessellatable containers using at least two container pallets or battery cell frameworks, each container pallet or battery cell framework including a lattice of cells arranged in a plane, the method comprising the steps of:
locating a bottom end of each container in the plurality of containers to a topside of a respective cell of a first container pallet or battery cell framework; and
locating undersides of cells of the second container pallet or battery cell framework to respective top ends of the plurality of containers, to sandwich the plurality of containers between the container pallets or battery cell frameworks.

In a standard warehouse, a pallet racking system is often used. This invention means that pallet can be used but the containers and the pallet(s) can be the infrastructure in the warehouse. The advantage of this is that the warehouse can be used for alternative uses when not full to capacity, as there would not be empty racking as in a traditional warehouse, making the warehouse more flexible in use and more cost effective.

The rack allows for more flexible and cost-effective storage in a warehouse, e.g. as part of a pallet racking system.

The container pallet may have any feature or combination of features of the first, second and third aspects of the invention.

The method may further comprise packing or securing a second plurality of containers using a third container pallet or battery cell framework which has a lattice of cells arranged in a plane, including the steps of:
locating a bottom end of each container of the second plurality of containers to a topside of a respective cell of the second container pallet or battery cell framework; and
locating undersides of cells of the third container pallet or battery cell framework to respective top ends of each of the second plurality of containers, to sandwich the second plurality of containers between the second and third container pallets or battery cell frameworks.

The steps outlined above may be repeated to introduce additional layers.

It will be appreciated that nested or stacked containers tend to be less stable the higher the stack of containers becomes, with increasing risk of containers toppling or support structures failing. Using the container pallet to engage the top of a layer of containers mitigates this cumulative instability and allows for higher stacking of containers without risking compromised stack stability.

According to a fifth aspect of the present invention, there is provided a rack for a plurality of containers in a tessellated or pseudo-tessellated arrangement, comprising a base, a first side wall extending from the base, a second side wall extending from
the base, the second side wall opposing the first side wall, a front, and a rear opposing the front, in which the first side wall includes a first corrugated face opposing the second side wall, and/or the second side wall includes a second corrugated face opposing the first side wall,
the base includes a base face extending between the first and second side walls from at or adjacent to the first and/or second corrugated faces, the base face and the or each corrugated face together defining a surface profile for conforming to at least some sides of the tessellated or pseudo-tessellated arrangement of containers, and
a cross-section of the surface profile remaining substantially identical or constant in a direction extending from the front to the rear of the rack for conforming to the arrangement of containers.

The rack allows containers, like those of GB2573330, GB2573356 and GB2581814, to be securely stored on their sides in a tessellated arrangement, e.g. in a warehouse.

The rack may hold a plurality of containers on their side during storage or transportation. The rack provides side wall support for the tessellated containers, to further stabilise the containers for transport or storage.

The term ‘rack’ is used in this specification to refer to a device suitable for storing containers in a racked arrangement. Although the rack includes one or multiple corrugated faces, the term ‘rack’ should not be construed to mean a rack for a pinion.

The term ‘corrugated’ may considered to mean a surface which includes a series of parallel ridges and grooves in an AB repeating pattern or in an ABAC repeating pattern.

That is, the corrugations may include alternating upward and downward slanting (when viewed in profile), or the corrugations may include alternating up/down slanting surfaces spaced apart by/interspersed with lateral surfaces.

The corrugated faces of the rack may be sized and shaped to correspond to the size and shape of the tessellated containers. The corrugated faces may abut one or more faces of the tessellated containers without substantial gaps between the containers and the corrugated faces.

The rack may include a modular cage or framework of parts, which may or may not be fixed together, for providing pallet racking.

The base face may be a corrugated face for conforming to at least part of the perimeter of the tessellated arrangement of containers. This is preferred when the containers have hexagonal profiles.

The rack may be modular. The base and side walls may be provided as individual pieces which can be connected together. The side walls may be constructed from individual pieces, each piece comprising a portion of the corrugated face. The modular nature of the side walls allows the height of the rack to be customised. The size of the rack may be tailored to the number of containers that need to be stored.

Each corrugated face may comprise engagement elements, such as elongate protrusions and/or recesses, for engaging with complementary engagement elements provided on the tessellated containers. The containers in abutment with the corrugated faces may be restricted against lateral movement by the corrugations. This stabilises the containers during storage and transport.

Lubricant may be provided on one or more surfaces of the rack for facilitating ingress and/or egress of a container. The lubricant may be provided by a coating or a fluid such as oil.

A plurality of container sleeves may be provided in the rack. Each sleeve may be suitable for receiving one of the plurality of containers. The container sleeves may be provided in a tessellated arrangement or lattice in the rack.

The lubricant may be provided on one or more internal surfaces of one or more of the sleeves for facilitating ingress and/or egress of a container.

External faces of the sleeve may be substantially free of protrusions or recesses.

The or each container sleeve may have a hexagonal profile. The sleeve may be shaped to receive the containers. That is, an internal profile of the sleeve may substantially correspond to the size and shape of the exterior of the container to be put into it.

The or each sleeve may have length substantially equal to the distance between the front and rear of the rack.

When the plurality of sleeves is in the rack, it may be considered as a form of honeycomb or pigeon hole structure, into which containers may be inserted and from which they may be removed. The rack and sleeves may be open at the front and/or at the rear.

The sleeve may be long enough to at least partially receive two containers. The containers in the sleeve may be coaxial or end-to-end. This facilitates using an incoming containers to help displace an outgoing container.

The rack can help to facilitate stock rotation. A first container can be inserted via the front or rear of the rack to displace a second container (optionally using compressed air to facilitate container movement) in the direction of the other face. This is described in more detail with respect to the sixth aspect of the invention.

According to a sixth aspect of the present invention, there is provided a container storage system or battery comprising:
a rack according to the fifth aspect of the invention, and one of:
a) a plurality of containers disposed in the rack in a tessellated or pseudo-tessellated arrangement, each container being removable from the rack independently of the other containers; and
b) a plurality of containers disposed in the rack in a tessellated or pseudo-tessellated arrangement, and first and/or second container pallets each according to the first aspect of the invention and disposed at the front and/or rear of the rack respectively.

According to a seventh aspect of the present invention, there is provided a method of container management using a rack according to the fifth aspect of the invention, and a plurality of tessellated or pseudo-tessellated containers in the rack, or a method of using a container storage system or battery according to the sixth aspect of the invention, the method comprising removing one or more of the containers from the rack and inserting one or more replacement containers into vacancies in the rack.

The system/method allows containers in the rack to be easily accessed and/or replaced as needed, facilitating stock management or rotation, for example. Where the pallets/frameworks remain attached to the containers, this facilitates secure transport so that the containers cannot move out of the plane of tessellation. Where the pallets/frameworks have been removed or are not present, the containers are easily removed/replaced from the rack by movement out of the plane of tessellation, which is useful in a warehouse, for example.

Where the containers are battery cells, then the method may be considered to be a method of servicing or repairing or maintaining or upgrading a battery. This may include recharging or renewing one or more cells and then returning them to the power cell bay, or exchanging one or more cells with replacement power cells. This may be beneficial if particular power cells are depleted, degraded or otherwise do not function at the required level.

Preferably, any given container in the rack is removable from the rack independently of the other containers. This applies particularly where the plurality of containers in the rack abut one another and have no vacancies or interstices, i.e. there are no ‘missing’ containers.

If one or more gaps are present in a close-packed arrangement of containers in the rack, then one or more containers may be removable independently of the others, but one or more of the others may not be removable without destabilising other containers in the rack. This problem may be substantially avoided by providing each container in a container sleeve which can remain in the rack, so all of the containers are independently removable for any number of containers in the rack.

The rack may comprise and feature or combination of features of the fifth aspect of the invention.

Containers may be inserted into the rack via the front and/or rear. The containers may be removed from the front and/or rear. The first container being removed from the rack may contain product with an earlier shelf life relative to the second container being inserted into the rack, for example. As newer containers are inserted into the front and/or rear face, older containers may be displaced. By inserting new containers are inserted into the front and/or rear face stock is easily rotated using the rack.

The following features may be provided in any aspect of the invention, but preferably for the battery cell framework and features/devices associated with the corresponding use case.

The power cell bay may comprise an electrically conductive material.

The power cell bay may comprise one or more electrical connections. The electrical connection(s) may be disposed on the upper and/or lower side walls. The electrical connection(s) may be disposed in the protrusions and/or recesses of the lower side walls for connection to corresponding portions of the containers (where the containers are power cells or battery cells).

The power cell bay may be provided as part of a battery comprising a plurality of power cells.

The battery may be a mobile device battery such as a smartphone battery, a tablet battery, a laptop battery, or a computer battery for another device, or a power pack battery for charging an electronic device.

The battery may be a vehicle battery, such as an electric vehicle or electric car battery for powering movement of the vehicle. The vehicle may be a car, bicycle, motorcycle, wheelchair, scooter, mobility scooter, van, bus, aeroplane, boat or another land, sea or air vehicle or device for personal transport. The battery may be disposed in a lower region of a vehicle or chassis thereof.

A topside or underside of the battery may be covered by a plate, for example. If the plate is removed, then individual battery cells may be accessed and removed as needed by movement of the battery cells out of the plane of tessellation (which may be movement along a substantially vertical axis).

Releasable securing or locking means may be provided to hold the containers in position. This may be preferred where the battery cells are being accessed from underneath. Any suitable connection may be used, for example mechanical, magnetic or electromagnetic.

The power cells may have any feature or combination of features of the containers discussed in this specification.

The power cell bay may facilitate servicing and/or maintenance of the battery. The power cell bay may be removed from a rack or block of power cells to provide access to individual power cells.

All aspects of the invention are intended for use with (or to be compatible with) a set of substantially identical tessesllatable containers. Examples of containers which may be tessellated together for use in any of the preceding aspects of the invention are discussed in the Applicant's patent applications GB2573330, GB2573356 and GB2581814. The disclosures of each of these documents are incorporated herein by reference.

For example, one, some or all of the containers may include any one or more of the following features in any combination.

The container may be shaped for hexagonal tessellation with other similar containers in a plane of tessellation. The container may have the overall form of a hexagonal prism.

The container may have a longitudinal extent and a first end portion, a second end portion and optionally a medial portion of the longitudinal extent.

The container may include engagement profiles at each of six regions of a circumference of the container. The six engagement profiles may include three pairs of mutually engageable, opposite-engagement protrusions and recesses out of and into the hexagonal prism form. Three adjacent ones of the engagement profiles may be protrusions and the three other ones of the engagement profiles may be recesses.

Each engagement profile may be formed along the full length of the container.

Each of the six engagement profiles may be shaped and positioned to, when engaged with the corresponding opposite profile of one of the said similar containers of the said tessellation, prevent relative movement of the similar container in a tangential direction along the circumference of the container, but allow substantially unimpeded disengagement of the two containers from each other by relative movement along a radial direction of the container in the plane of tessellation.

The protrusions and recesses may be located in one or both of the first and second end portions. Where provided, the medial portion may be substantially free of the protrusions and recesses.

The or each container may be made of metal.

### BRIEF DESCRIPTION OF THE DRAWINGS

For a better understanding of the present invention, and to show more clearly how it may be carried into effect, reference will now be made by way of example only to the accompanying drawings, in which:

FIG. 1 shows a perspective view of a first embodiment of a container pallet or battery cell framework;

FIG. 2 shows perspective views of a container positioned between two pallets or frameworks of FIG. 1;

FIG. 3 shows a top perspective view of a plurality of containers in a close-packed arrangement between two pallets or frameworks of FIG. 1;

FIG. 4 shows a side view of the containers and pallets/frameworks of FIG. 3, with a second layer of containers and a second pallet/framework;

FIG. 5a shows a perspective view of a second embodiment of a container pallet or battery cell framework, including a peripheral lip and an exemplary container;

FIG. 5b shows a perspective view of a plurality of containers in a close-packed arrangement between two pallets or frameworks of FIG. 5a;

FIG. 6 shows first and second perspective views of a container pallet module or battery cell framework module;

FIG. 7 shows perspective views of a plurality of modules of FIG. 6 being connected together into a modular container pallet or modular battery cell framework;

FIG. 8 shows perspective views of first and second types of foot or support/spacer element for a container pallet or battery cell framework;

FIG. 9a shows top and base perspective views of the feet of FIG. 8 connected to the module of FIG. 5a;

FIG. 9b shows base perspective views of a third type of foot or support/spacer element being connected to the module of FIG. 5a;

FIG. 10 shows a perspective view of a plurality of feet of FIG. 8 connected to the modular pallet or framework of FIG. 7;

FIG. 11 shows a perspective view of a first embodiment of a rack;

FIG. 12 shows a perspective view of a second embodiment of a rack;

FIG. 13a shows a perspective view of a plurality of containers between modular pallets/frameworks of FIG. 7 being loaded into the rack of FIG. 12;

FIG. 13b shows a front view of the rack of FIG. 13a, with the containers in situ;

FIG. 14 shows perspective views of a container insertable into a container sleeve;

FIG. 15 shows a perspective view of a plurality of container sleeves and containers of FIG. 14, provided in the rack of FIG. 11;

FIG. 16 shows a cross-sectional perspective view of a second embodiment of a container sleeve, and two containers therein; and

FIG. 17 shows a perspective view of a plurality of container sleeves and containers of FIG. 16, provided in another embodiment of a rack.

### DESCRIPTION OF PREFERRED EMBODIMENTS

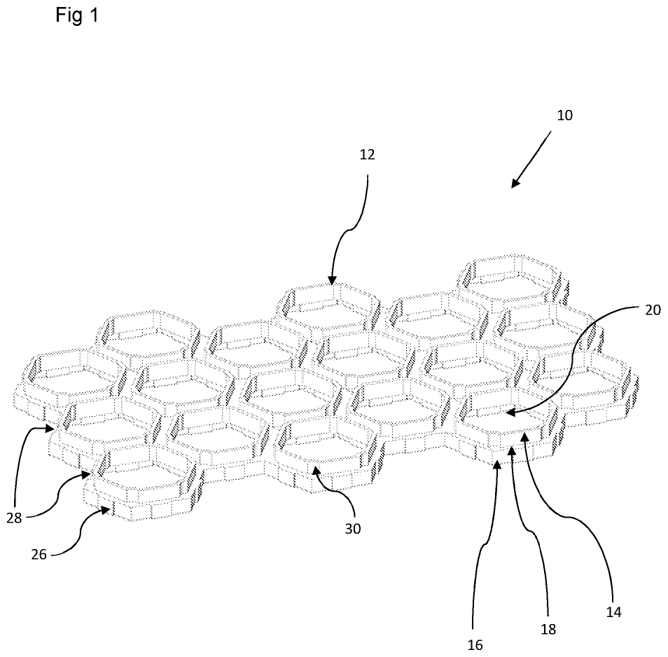

Referring firstly to FIG. 1, a first embodiment of a container pallet (or a battery cell framework) for a plurality of tessellated containers is generally shown at 10. It is shown in an upright orientation which may be a floor-standing configuration, and subsequent references to upper and lower should be construed when considering FIG. 1 and accompanying text in the normal orientation of that page. However, in the case of a battery cell framework, it will be appreciated that a battery including the framework may be provided in any suitable orientation for powering a device.

The container pallet 10 comprises a plurality of cells 12. Whilst eighteen cells are provided in this embodiment, it will be appreciated that the pallet 10 may be provided with any number of cells (although preferably the cells are arranged to minimise the perimeter length of the pallet as a whole).

The cells 12 are arranged in a horizontal plane. Each cell 12 has a regular hexagonal profile. Each cell 12 is substantially identical in this embodiment. Each cell 12 is tessellated with adjacent cells 12 to form a honeycomb-type structure.

The term “tessellation” is used in this description to mean a regular packing arrangement which results in a repeated array of the same shape, or complementary shapes, in a plane. The term “tessellation” does not necessarily imply an absence of interstices between tessellated elements.

Each cell 12 has an upper side wall 14 and a lower side wall 16. The upper side wall 14 extends in a direction above the horizontal plane. The lower side wall 16 extends in a direction below the horizontal plane. The upper side wall 14 extends in a direction substantially parallel to the lower side wall 16. The upper side wall 14 is inset from the lower side wall 16. The upper side wall 14 is inset from the lower side wall 16 by a container receiving surface (or lateral wall) 18. The container receiving surface 18 extends from a bottom of an exterior of the upper side wall 14 to a top of the exterior of the lower side wall 16. The container receiving surface 18 extends in a direction perpendicular to the lower side wall 16. Each cell 12 is sized and shaped to receive a single container 500 during use.

As described above, the cells 12 are tessellated to form a honeycomb structure, and the lower side walls 16 of adjacent cells 12 form a single structure in this embodiment.

The container receiving surfaces 18 provide spaces between the upper side walls 14 of adjacent cells 12.

In each cell 12, the upper side wall 14 and lower side wall 16 define a through aperture 20. The cell aperture 20 forms a majority of the cross-section of the cell 12. Near edges of apertures 20 of adjacent cells are spaced apart by the thicknesses of the side walls between them.

For each cell in this embodiment, the upper side wall 14 has a substantially hexagonal profile. The lower side wall 16 has a substantially hexagonal profile. The hexagonal profile of the lower side wall 16 has a greater cross-sectional area than the hexagonal profile of the upper side wall 14. The upper and lower side walls 14, 16, have concentric hexagonal profiles, i.e. they share a common centre.

The lower side wall 16 includes a plurality of engagement elements on its side faces.

In this embodiment, each face has a single engagement element but it will be appreciated that any suitable number of engagement elements may be provided per face in other embodiments. This includes multiple engagement elements per face and different numbers of engagement elements per face, including not providing engagement elements on every side face.

The engagement elements include three protrusions 26 and three recesses 28. The three protrusions 26 are provided on respective consecutive sides of each lower side wall as seen in FIG. 1. The three recesses 28 are provided on the other three respective consecutive sides of each lower side wall. It will be appreciated that inner sides of the lower side walls can be seen through the apertures 20, and that protrusions on those inner sides correspond to recesses 28 in the outer sides of the lower side walls. However, it is not essential for the recesses in the exterior of the lower side wall to have corresponding inner protrusions. The engagement elements are discussed in more detail below.

Each upper side wall 14 includes a plurality of recesses 30. In this embodiment, there are six recesses 30 per upper side wall. The recesses 30 in this embodiment are located at the corners of the hexagonal profile. Each recess 30 has a curved or arcuate profile. Each recess 30 extends from the lateral container receiving surface to the top of the upper side wall.

It will be appreciated that any suitable number of recesses 30 may be provided per upper wall. The number of recesses may be the same as or different from (higher or lower) the number of sides of the polygonal profile. Whilst the recesses 30 are in the corners here, the recesses may alternatively or additionally be provided partway along the exterior faces of the upper side wall.

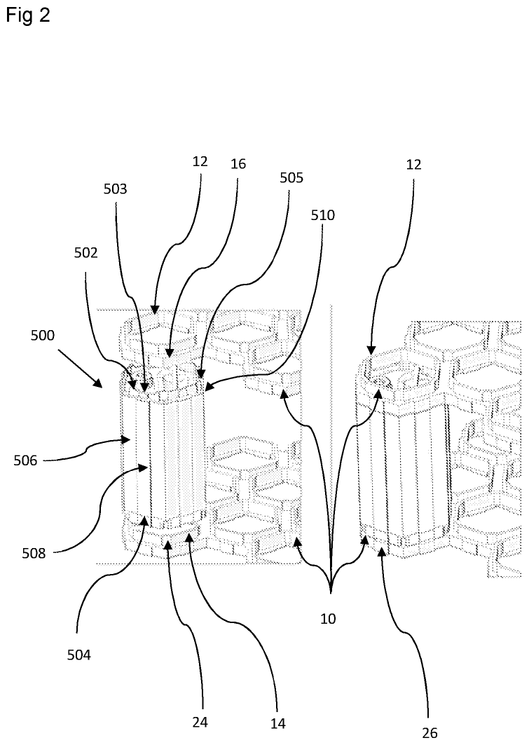

Referring also to FIG. 2, the structure of each cell 10 is tailored to receive a tessellatable container 500. The tessellatable container has the form of a hexagonal prism with six major external side faces. Examples of suitable containers are described in GB2573330, GB2573356 and GB2581814. The container 500 has a top end 502 and a bottom end 504. The container 500 has a medial portion 506 between the top end 502 and bottom end 504. The upper side wall 14 of a first container pallet 10 is configured to fit the bottom end 504 of the container 500. The lower side wall 16 of a second container pallet 10 is configured to fit the top end 502 of the container 500.

The bottom end 504 of the container has a height substantially similar to the height of the upper side wall 14. The upper side wall 14 can be considered as a container engagement profile. The bottom end 504 has a complementary engagement profile for receiving the upper side wall 14. During use, the upper side wall 14 is flush with the bottom end 504 of the container 500. The upper sidewall 14 inhibits movement of the container 500 in a direction parallel to the horizontal plane of the container pallet 10.

That is, it inhibits lateral movement of the container 500.

The medial portion 506 has a profile substantially identical to the profile of the lower side wall 16. When the upper side wall 14 is flush with the bottom end 504 of the container 500, the lower side wall 16 is disposed substantially in the vertical plane of the external faces of the medial portion 506.

The top end 502 has a height substantially similar to the height of the lower side wall 16. The lower side wall 16 can be considered as a container engagement profile. The top end 502 has a complementary engagement profile for being received by the lower side wall 16 of the second container pallet. During use, the top end 502 is flush with that lower side wall 16. Like the upper sidewall of the first pallet, the lower sidewall 16 of the second pallet inhibits movement of the container 500 in a direction parallel to the horizontal plane of the container pallet 10.

The top end 502 is indented from the medial portion 506 of the container 500. The indentation is in a radially inwards direction relative to the six major sides of the container. The indentation of the top end 502 is substantially the same distance as the width of lower side walls 16 of the container pallet 10.

For each container in this embodiment, each external face of the container 500 has either a protrusion 508 or a recess 510. The recess 510 is sized and shaped like an opposite of the protrusion 508, so they can fit together in a complementary manner.

The protrusions 508 and recesses 510 each extend along a length of the medial portion 506 (i.e. between the top end 502 and bottom end 504).

To provide the containers 500 tessellated side-by-side in a plane, each container may be located to one of the cells 12, in orientations where one container in a given pair of adjacent containers has a protrusion 508 and the other container in the pair has a corresponding recess 510. In this embodiment, the container pallet 10 is arranged to receive containers 500 which have recesses 510 and protrusions 508.

In other embodiments, at least part of the medial portion 506 may be substantially free of protrusions 508 and recesses 510 as disclosed in GB2581814.

The top end 502 features protrusions 503 and recesses 505 which correspond to the protrusions 26 and recesses 28 in the lower side wall 16.

The container pallet 10 can tesselate with adjacent container pallets 10 in the same manner as the containers 500 themselves, via the corresponding engagement elements.

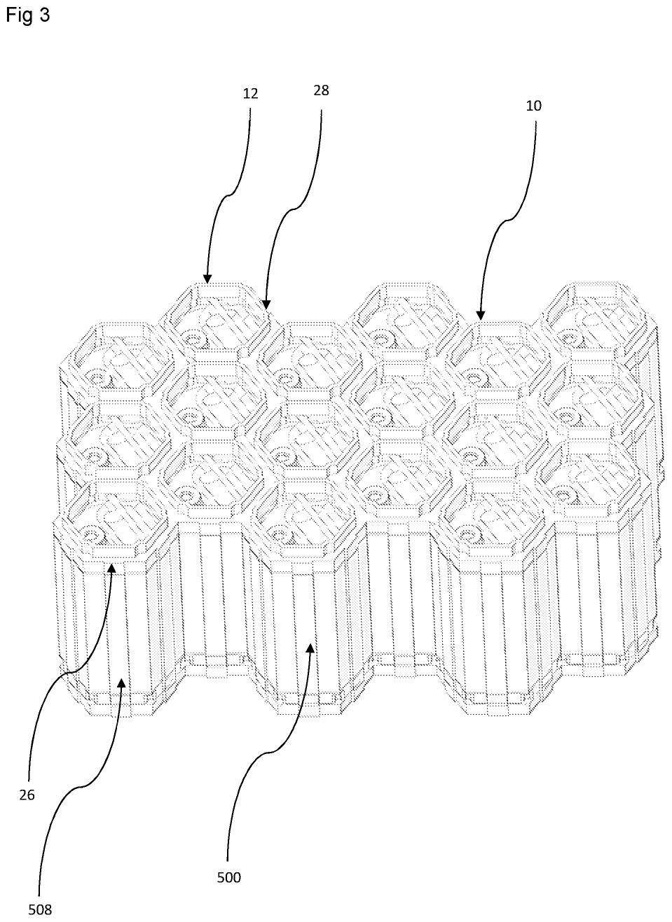

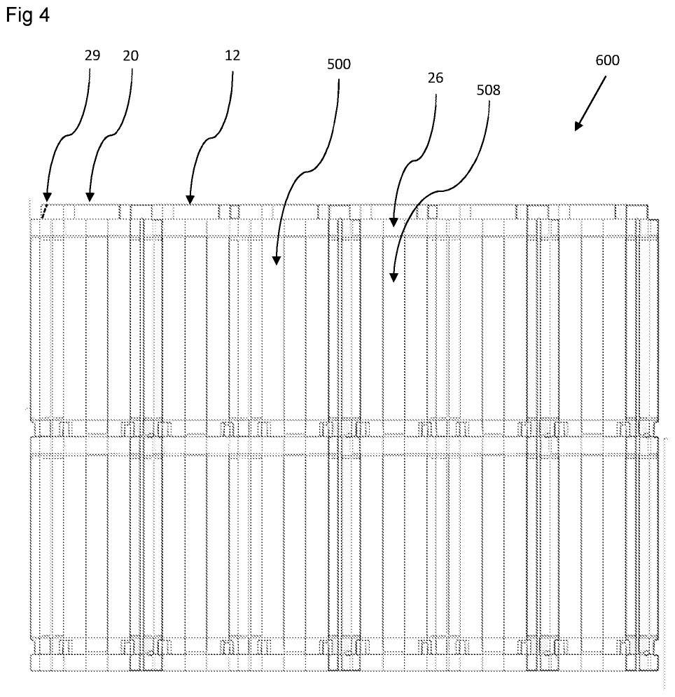

As can be seen in FIGS. 3 and 4, the containers 500 can be retained in the container pallet 10 in a close-packed arrangement. Single use packing materials, such as clingwrap, are not required to secure the containers. In this particular case, a second container pallet is shown on top of the layer of containers, but the second pallet is not essential if a single layer of containers is being stored, for example.

Multiple layers of container pallets 10 and containers 500 may be stacked on top of each other in the manner described above to form a layered structure 600, e.g. two layers of containers as shown in FIG. 4. The protrusions 508 and recesses 510 along the length of the containers 500 and the corresponding protrusions 26 and recesses 28 of the lower side walls 16 of the container pallets 10 can be considered to form a single protrusion or recess on each face of the layered structure 600. The layered structure 600 can tessellate with adjacent layered structures 600 in a manner similar to the container 500 and container pallet 10.

The dashed line 29 in FIG. 4 shows how, in other embodiments, the upper side wall 14 may extend in a direction angled towards a centre of the cell. That is, how the upper side wall of each pallet cell may be angled inwards. The angle between the horizontal plane and the upper side wall 14 may be between 70° and 90°.

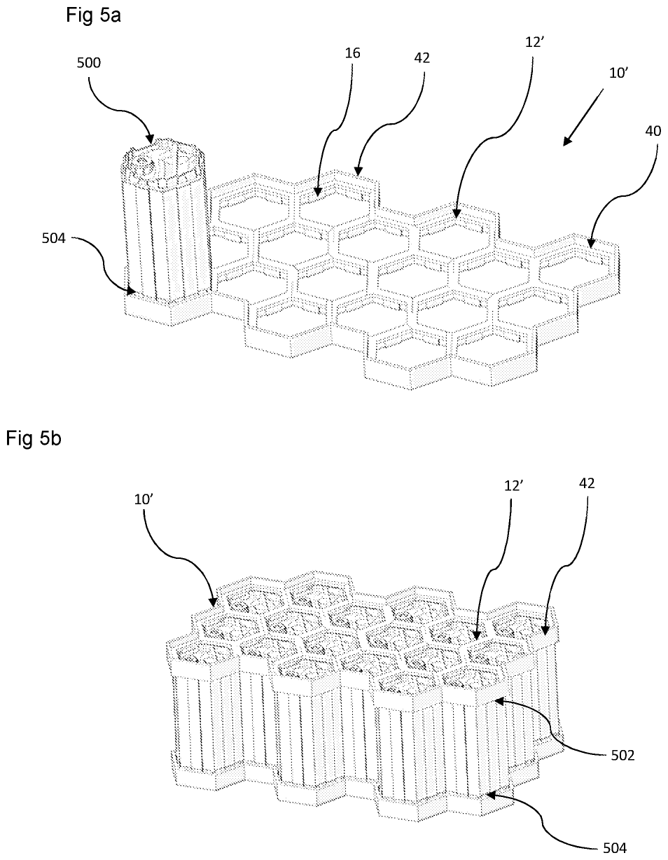

FIGS. 5a and 5b show a second embodiment of the container pallet, generally indicated at 10′, with an exemplary container 500 in situ on the pallet. The container pallet 10′ is substantially similar to the container pallet 10 described in the first embodiment unless stated otherwise. Where possible, like reference numerals are used to like features relative to the first embodiment.

In this embodiment, upper side walls 14 are not included in each cell 12′. It will be understood that some or all of the cells 12′ may possess upper side walls 14 in other embodiments.

The container pallet 10′ has a periphery 40. The periphery 40 is formed from faces of the lower side walls 16 which are not directly adjacent to and facing another cell 12′.

In other words, the periphery 40 is defined by sides of the outermost cells.

In this embodiment, a lip 42 or peripheral wall is provided around a periphery 40 of the container pallet 10′. The lip 42 prevents the containers 500 from sliding sideways out of the container pallet 10′. The lip 42 extends above and below the horizontal plane of the container pallet 10′. The lip 42 extends in a direction substantially perpendicular to the horizontal plane of the container pallet 10′.

Containers 500 can be loaded onto the pallet 10′ by locating a first container to a cell such that it fits neatly against the lip 42, and then loading additional containers such that they fit to that container and where applicable another portion of the lip 42. The orientations of the containers should again be such that, in a given pair of adjacent containers, one container has a protrusion 508 and the other container in the pair has a corresponding recess 510 facing it.

It will be appreciated that the peripheral lip in this embodiment extends around the full periphery of the pallet 10′, but that in other embodiments the lip may extend only partway around the periphery or may be an interrupted lip (e.g. with a plurality of lip walls spaced apart around the periphery).

During use, when containers are provided on the pallet 10′, the lip 42 extends above the plane of the container pallet 10′ to a height just above the bottom end 504 of a container 500 disposed on the container pallet 10′. The bottom end 504 of the container 500 may be substantially flush with the height of the lip 42 during use.

FIG. 5b shows a plurality of containers 500 sandwiched between two container pallets 10′. During use, the lip 42 extends below the horizontal plane of the upper container pallet 10′ to a height just below the top end 502 of a container 500 disposed below that container pallet 10′. The top end 502 of the container 500 may be substantially flush with the lip 42 during use.

When viewed from above, the lips 42 of each container pallet 10′ lie proud of the side faces of each container 500, unlike the pallet of the first embodiment.

In this embodiment, lateral movement of the individual containers 500 is prevented by the tessellation of the containers and the lip 42.

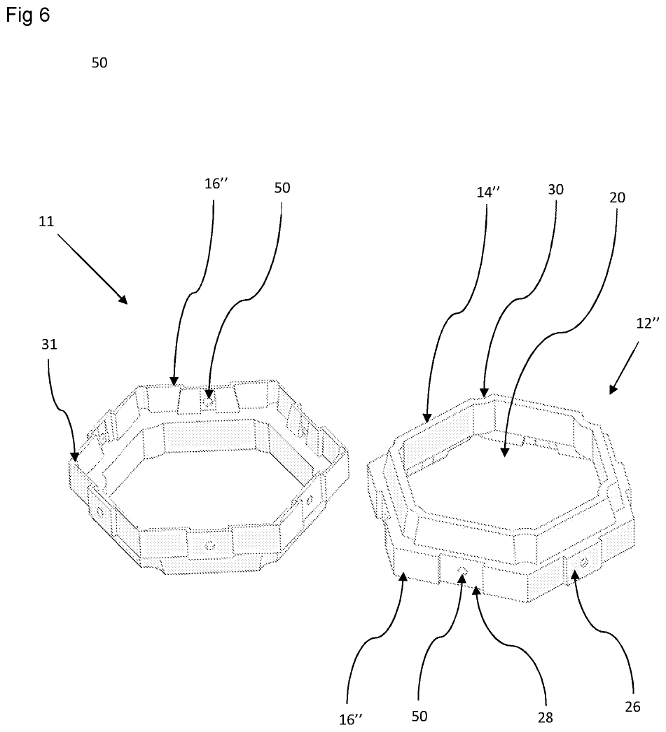

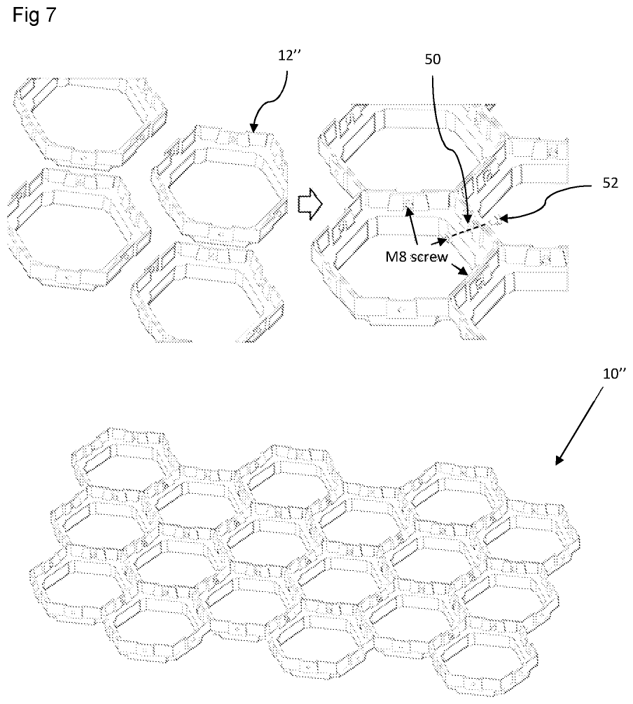

Referring now to FIGS. 6 to 7, a third embodiment of the container pallet of battery cell framework is indicated generally at 10″. Where possible, like reference numerals are used to like features relative to the first embodiment. In some ways, the features of the container pallet 10″ are substantially similar to that of the first embodiment. However, in this embodiment each cell 12″ is provided by an individual container pallet module or battery framework module 11, shown in FIG. 6.

In this embodiment, a lower side wall 16″ of the cell of the module 11 has module-to-module connection means. In this embodiment, there are six connection means corresponding to the six faces of the hexagonal module (although any suitable number of connection means may be provided in other embodiments). It will be appreciated that other embodiments of the module 11 may have other polygonal profiles as discussed generally above.

In this embodiment, the connection means include apertures 50 through each major face of the polygonal profile, i.e. through each of the six main sides of the lower side wall 16″. The connection means is disposed on each face of the lower side wall 16′.

The connection means provides a way to adjacent cells 12″ together. The apertures 50 are disposed through the centre of each face of the lower side wall 16″. The apertures 50 are disposed through part of (or a centre of) each of the protrusions 26 and recesses 28. The apertures 50 can receive screws 52 or other fixing means which are used to connect the modules 11 together (e.g. using corresponding nuts and optionally washers), as shown in FIG. 7. The screw apertures 50 and screws 52 allow the modules 11 to be releasably secured to each other.

The connection means also include the engagement elements (protrusions 26 and recesses 28) which are slotted together or mutually engaged to line up pairs of the apertures 50 on separate modules 11 to be secured together.

In the six main interior corners of the lower side wall 16″, corresponding to corners of the hexagonal profile, circular or curved recesses 31 are provided. These are not essential but may be provided in some or all of the cells of any other embodiment.

Multiple modules 11 can be connected to form a container pallet 10″ similar to that of the first and second embodiments. However, due to the modular nature of the cells 12″ in this embodiment, the number and arrangement of cells 12″ in the container pallet 10″ can be fully customised.

In this embodiment, the upper side wall 14′ extends in a direction angled towards a centre of the aperture 20, i.e. it is slanted inwards. The angle between the horizontal plane and the upper side wall 14′ is between 70° and 90°.

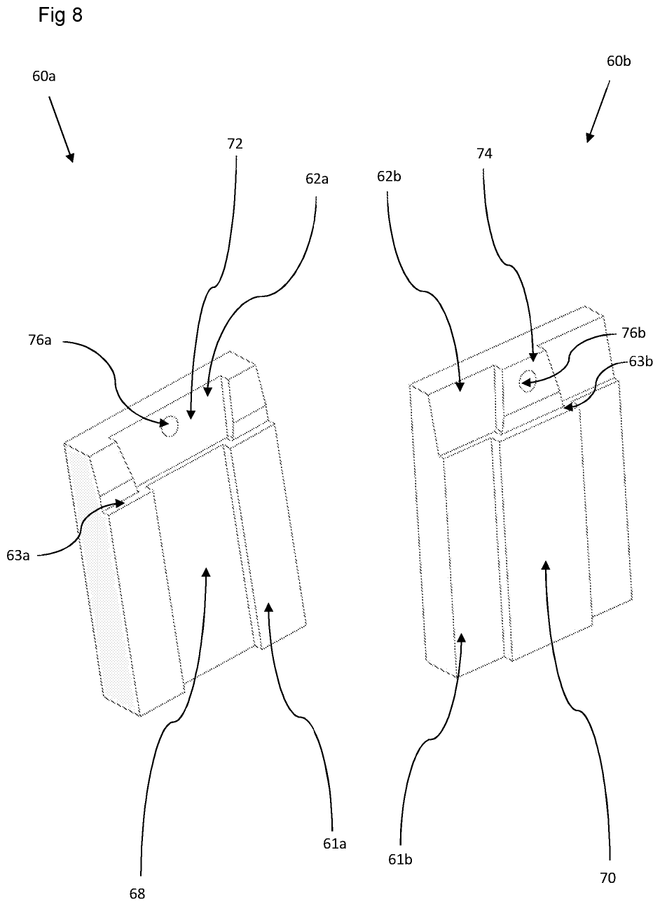

Referring now to FIG. 8, two container pallet feet are indicated generally at 60a and 60b. The first type of foot 60a has a recess for corresponding to or continuing a recess in the pallet or module in earlier embodiments. The second type of foot 60b has a protrusion for corresponding to or continuing a protrusion in the pallet or module in earlier embodiments.

The container pallet feet 60a, 60b may be used to raise the container pallet 10, relative to the ground to provide a gap for the tines of a forklift. If used in a battery cell framework, the feet may be considered to be spacer elements or supporting elements. Each type of foot 60a, 60b includes a substantially rectangular body 61a, 61b. A pallet connection portion 62a, 62b extends from each rectangular body 61a, 61b. In this embodiment, the connection portions are comparatively thinner than the bodies 61a, 61b. The container pallet feet 60a, 60b can be received by the lower side wall 16 of a pallet or module as described below.

The first type of foot 60a has an elongate recess 68. The recess 68 corresponds to one of the recesses 28 in the lower side walls 16 of the pallet cell 12. In other words, when the foot 60a is received by the lower side wall 16 of the cell 12, the foot 60a forms an extension of the recess 28 in the lower side wall 16.

The second type of foot 60b has an elongate protrusion 70. The container pallet foot protrusion 70 corresponds to one of the protrusions 26 in the lower side wall 16 of a pallet cell 12. In other words, when the foot 60b is received by the lower side wall 16 of the cell 12, the foot 60b forms an extension of the protrusion 26 in the lower side wall 16.

The pallet connection portions 62a, 62b are each receivable by the container pallet 10 during use. Each pallet connection portion 62a, 62b is inset from the recessed/protruding side of the rectangular body 61a, 61b. The offset provides a lower side wall receiving face 63a, 63b for seating against an interior face of the cell 12.

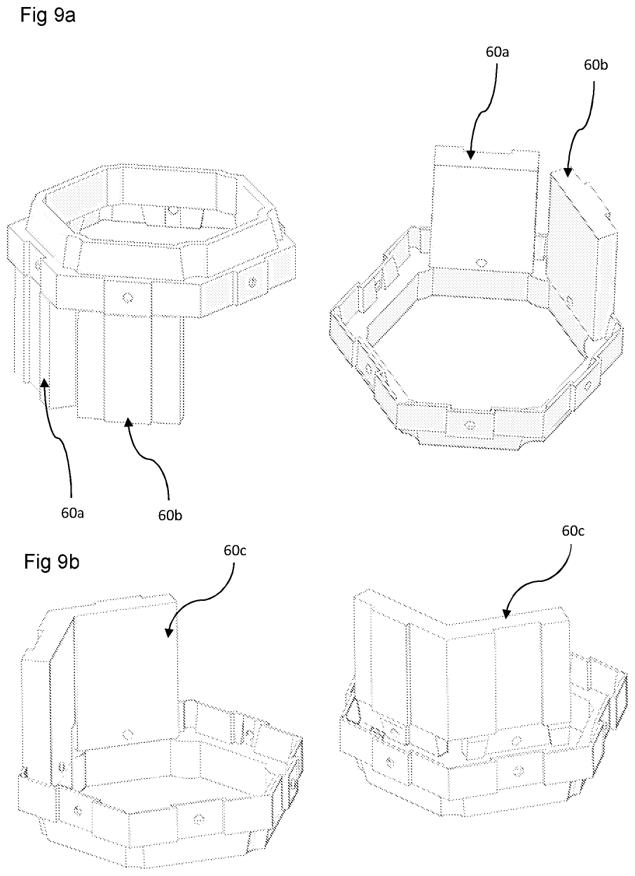

The pallet connection portion 62a of the foot 60a has a second recess 72. The second recess 72 is disposed in the middle of the connection portion 62a. The recess 72 corresponds to the cell recess 28 in the lower side wall 16 which receives the connection portion 62a, as shown in FIG. 9a.

The pallet connection portion 62b of the foot 60b has a second protrusion 74. The protrusion 74 is disposed in the middle of the connection portion 62b. The protrusion 74 corresponds to the cell protrusion 26 in the lower side wall 16 which receives the connection portion 62b, as shown in FIG. 9a.

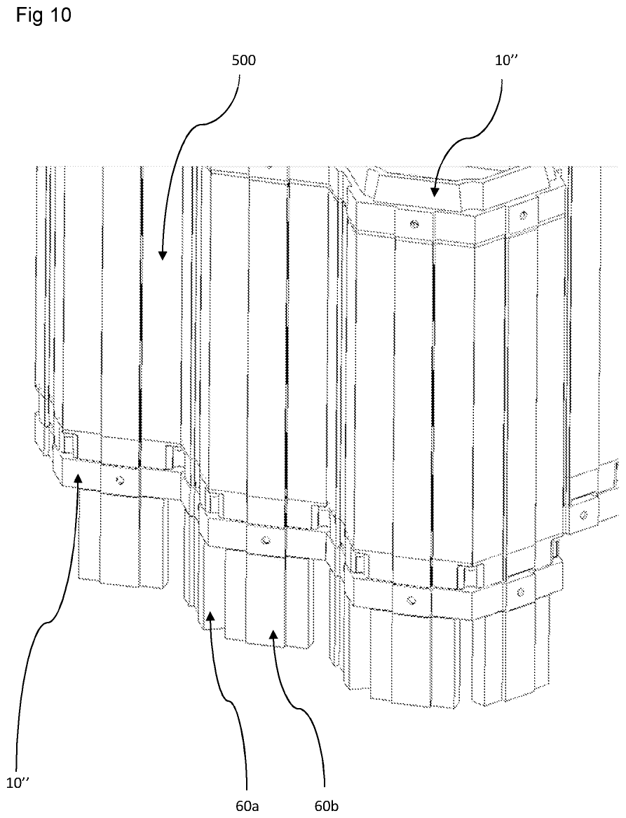

The pallet connection portions 62a, 62b include apertures 76a, 76b through the pallet connection recess 72 and pallet connection protrusion 74 respectively, so that they can be secured using the same screws or bolts used to interconnect the modules 11, for example. For the non-modular pallets, lateral apertures may still be provided through some or all of the lower side walls in order to facilitate securing feet thereto. The container pallet feet 60a, 60b can be attached to the container pallet as shown in FIGS. 9a, 9b and 10, using fixing means such as screws (not shown). In FIG. 9a, the container pallet feet 60a, 60b correspond to a single side of the lower side wall 16. However, the two container pallet feet 60a, 60b may be provided as a single piece, generally indicated at 60c in FIG. 9b, where the foot 60c has two portions angled with respect to each other by an internal angle of the hexagonal (or other) profile of the cell. This may provide more stability for the pallet, e.g. at corners of a pallet.

While the feet are depicted as attached to the modular pallet of the third embodiment, it will be appreciated that the container pallet feet 60a, 60b can be connected to the cells 12, 12′ of the first or second embodiments where a suitable connection means is provided.

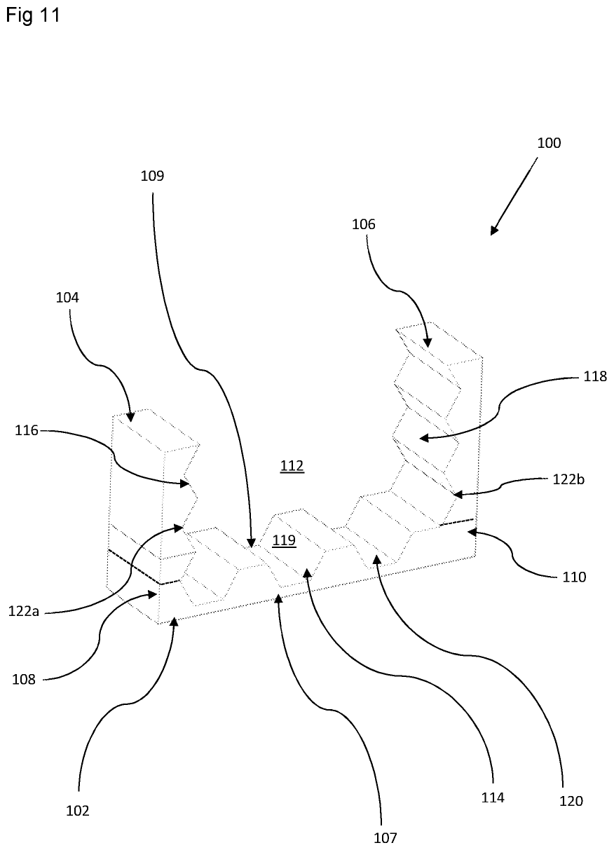

Referring now to FIG. 11, a first embodiment of a rack for receiving or holding a plurality of tessellated containers 500 on their side is indicated generally at 100. The rack may be provided in a warehouse or other storage environment.

The rack 100 has a base 102. The rack has a first side wall 104. The rack 100 has a second side wall 106. The rack 100 is approximately U-shaped in profile. The rack is open at a front side 107. The rack is open at a rear side 109.

Boundaries between the base 102 and side walls 104, 106 are shown by the dashed lines.

The first side wall 104 extends from a first end 108 of the base wall 102. The first side wall 104 extends in a direction substantially perpendicular to the base wall 102. The second side wall 106 extends from a second end 110 of the base wall 102. The second side wall 106 extends in a direction substantially perpendicular to the base wall 102, and substantially parallel to the first wall.

The base and side walls 102, 104, 106 together define a container receiving region 112. The container receiving region 112 extends from the front 107 to the rear 109.

The receiving region 112 can receive containers 500 and container pallets described above.

The base wall 102 has a corrugated base face 114. The first side wall has a first corrugated side face 116. The first corrugated side face 116 faces towards the second side wall 106. The second side wall 106 has a second corrugated side face 118. The second corrugated side face 118 faces the first side wall 104. The corrugated faces 114, 116, 118 define a corrugated surface profile 119. The surface profile 119 substantially conforms to the shapes of the containers 500 when they are disposed in the receiving region 112. A cross-section of the surface profile remains substantially constant the front to the rear of the rack.

The rack may have a depth corresponding to the end-to-end length of a container 500.

To put containers into the rack, the containers 500 are disposed in the receiving region 112 on their sides. In other words, the top end 502 of each container 500 faces towards the front 107 or rear 109 and the bottom end 504 faces towards the other of the front 107 and rear 109. The external sides of the outermost containers 500 abut the corrugated faces 114, 116, 118.

The corrugations enable the base 102 and side walls 104, 106 to receive the containers 500 in their tessellated arrangement. The corrugation of the base face 114 includes a layer of trapezoidal recesses 120 (or trough-shaped recesses) spaced apart by trapezoidal protrusions or intervening walls. In this embodiment, the layer of trapezoidal recesses 120 has three trapezoidal recesses 120 and three corresponding walls (two between pairs of adjacent troughs, and one at the far end by the second side wall), but it will be appreciated that any suitable number of corrugations may be provided.

In this embodiment, the trapezoidal recesses 120 are substantially identical to each other. The trapezoidal recesses 120 are aligned on a horizontal plane.

The corrugations of the first and second side walls 104, 106 comprise v-shaped recesses 122a, 122b. Each v-shaped recess 122ab fits about two external sides of the outermost containers 500 during use. Each v-shaped recess is directly adjacent to another v-shaped recess on the respective side wall 104, 106, to form the corrugated internal faces 116, 118.

In use, the layer of trapezoidal recesses 120 receives a first layer of the containers 500. The first layer may be considered to have three containers 500, where containers 500 in a layer must be aligned on a common horizontal plane, i.e. at the same height above the base.

A second layer of the containers 500 can be introduced at a height above the first layer of containers 500. Those containers 500 then lie on the trapezoidal protrusions. There are three containers 500 in the second layer. The containers 500 of the second layer of containers 500 tesselate with the containers 500 of the first layer of containers 500.

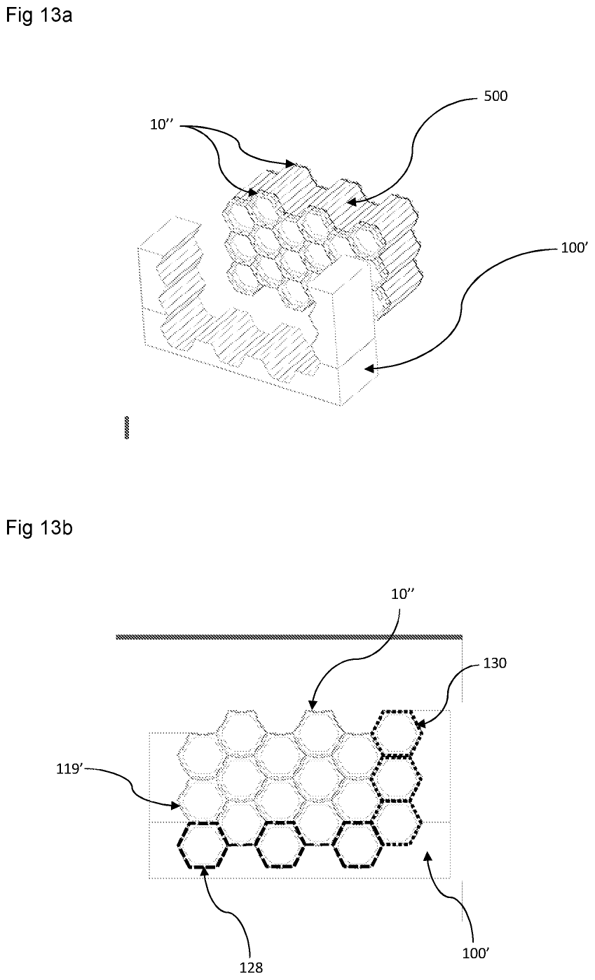

Subsequent layers of containers for this embodiment can include third, fourth, fifth and sixth layers. Each layer has three containers 500 aligned on a horizontal plane. This is best shown in FIG. 13b with respect to the second embodiment of the rack 100′ described below.

In some embodiments of the rack, each v-shaped recess 122a of the first side face 116 is aligned with a plane of a peak between two v-shaped recesses 122b on the second side face 118. That is, the v-shaped recesses on the two side walls may be anti-aligned. In other embodiments, peaks between each v-shaped recess 122a of the first side face 166 may oppose peaks between corresponding v-shaped recesses 122b at equivalent levels on the second side face 118. That is, the v-shaped recesses on the two side walls may be in alignment.

In other words, the corrugations of the first and second side faces 116, 118 may be considered in phase or out of phase depending on whether the v-shaped recesses are centred on common planes or not.

The rack 100 depicted in FIG. 11 is sized to contain six columns of tessellated containers 500 where a column extends in a direction perpendicular to a layer. This is best shown in FIG. 13b with respect to the second embodiment of the rack 100′.

In this embodiment, the rack 100 is modular. The first and second side walls 104, 106 are provided as independent pieces which are detachably connected to the base 102.

Additional side wall pieces may be attached to increase the height of the rack 100. In other embodiments, the rack 100 may be integrally formed, or the modules may be different heights and/or widths to those depicted.

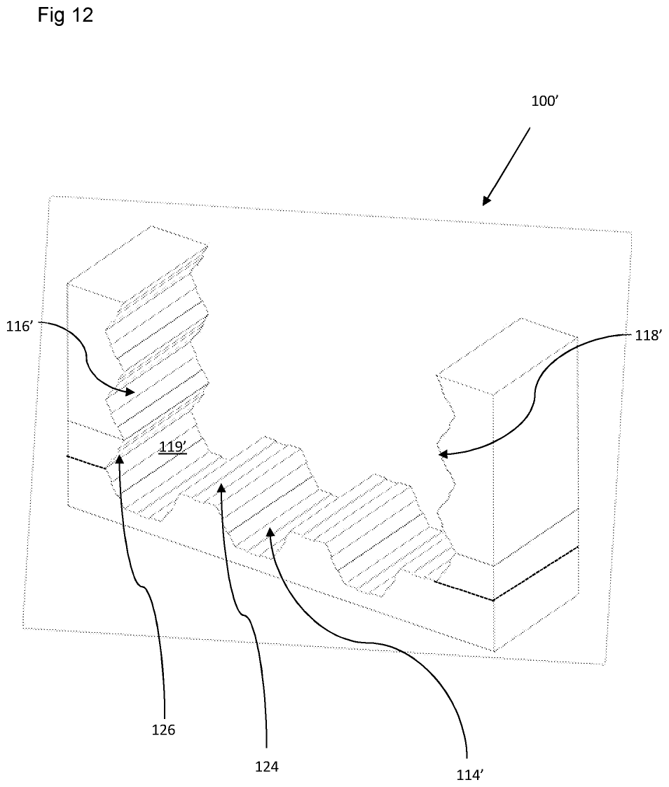

Referring now to FIG. 12, a second embodiment of a rack is generally shown at 100′.

The second embodiment is substantially similar to the first embodiment unless stated otherwise. Like reference numerals will be used to indicate like features.

In the second embodiment, the first, second and third inner faces 114′, 116′, 118′ include engagement elements. The engagement elements are configured to engage with the complementary protrusions or recesses of the containers 500. The engagement elements include elongate recesses 124 and protrusions 126. The recesses 124 and protrusions 126 extend across the rack 200′ from the rear face to the front face. The recesses 124 and protrusions 126 correspond to the recesses 506, 28 and protrusions 508, 26 in the containers 500 and container pallets 10 described above.

The exact arrangement of protrusions and recesses (i.e. which face of which corrugation has a recess or a protrusion) can be selected to facilitate engagement with a tessellated group of containers. For example, in this embodiment, the base corrugations only has recesses, whilst sides of the v-shaped side wall corrugations alternate between protrusions (for sides facing towards the base) and recesses (for sides facing away from the base).

Save for the protrusions 126 and recesses 124, the general surface profile 119′ of the rack 100′ is substantially identical to that of the first embodiment.

FIGS. 13a and 13b show a plurality of tessellated containers 500 in the rack 100′.

The containers 500 are in a tessellated arrangement. In this embodiment, the plurality of containers 500 are enclosed by two modular container pallets 10″ of the third embodiment at either end (but other embodiments of container pallet could also be used, e.g. the first embodiment of pallet 10).

FIG. 13b shows the surface profile 119′ of the rack 100′ conforming to the shape of the tessellated arrangement of containers 500. The rack 100′ contains six layers 128 of three containers 500 each, where a first layer is outlined by dashed lines. The rack 100′ contains six columns 130 of three containers 500, where a column is also outlined by a second series of dashed lines.

In other embodiments, the rack 100′ may contain a different number of layers 128 and/or a different number of columns 130. The number of corrugations may be adjusted accordingly.

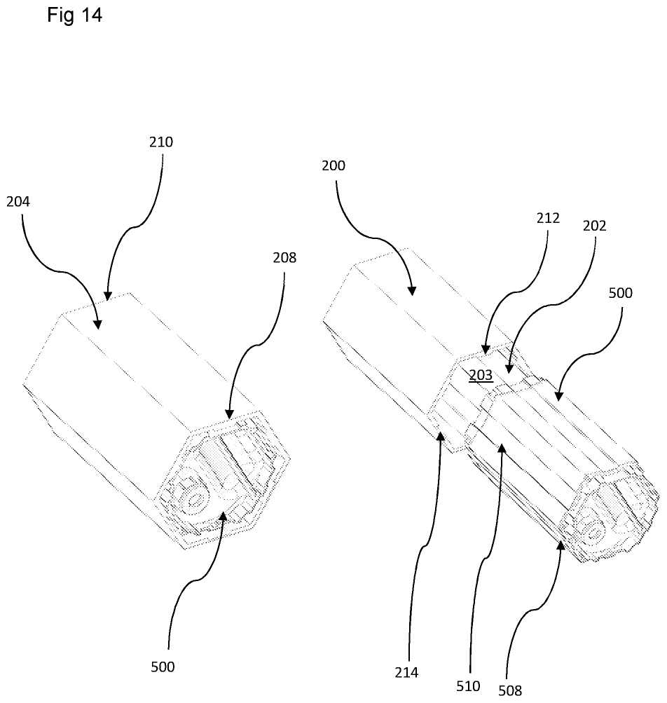

Referring to FIG. 14, one of the containers 500 is shown filling a container sleeve which indicated generally at 200. The sleeve is open at a proximal end 208 for allowing a container in and out. The sleeve is also open at a distal end 210 in this embodiment, although that is not essential. In this embodiment, the sleeve 200 has a length roughly equal to or slightly more than the length of the container 500.

The sleeve 200 has internal faces 202 corresponding to the container. The sleeve has an external profile 204 which can tesselate together with other container sleeves 200.

The external faces of the containers 500 abut the internal face 202 when disposed in the sleeve 200.

A lubricant 203 can provided on the internal faces 202. The lubricant facilitates insertion of the container 500 into the sleeve 200 (or removal from it). In this embodiment, the lubricant 203 can provided by a coating or a fluid.

The internal faces 202 have protrusions 212 and recesses 214 corresponding to those already described for the container 500 above. The protrusions 212 and recesses 214 extend along the length of the sleeve 200. The protrusions 512 of the sleeve 200 are received by the recesses 210 of the container 500. The recesses 514 of the sleeve 20 receive the protrusions 508 of the container 500. The container 500 can slide in and out of the sleeve 200 substantially unhindered.

Note that in other embodiments the internal faces 202 of the sleeve 200 may be substantially free of protrusions 212 and/or recesses 214.

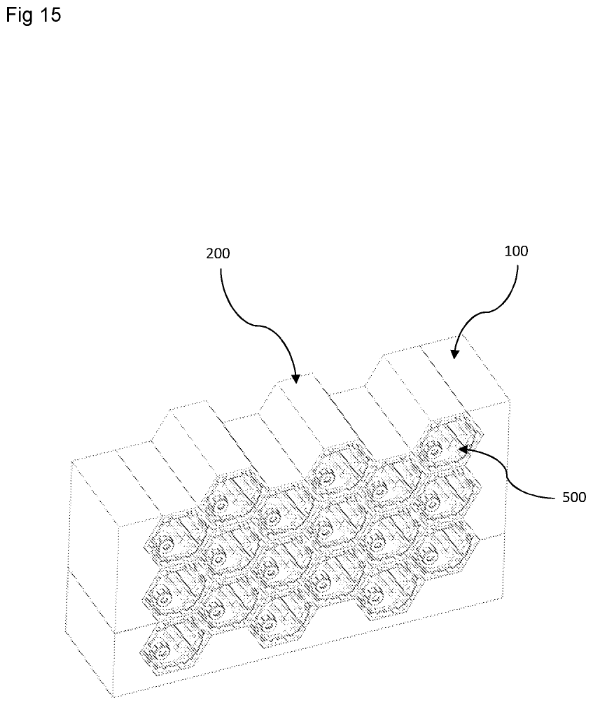

Referring now to FIG. 15, the container sleeves 200 are shown stacked inside the first embodiment of the rack 100. The containers 500 are tessellatable but spaced slightly apart due to the container sleeves, so the containers may be considered to be pseudo-tessellated. The container sleeves are in a tessellated arrangement.

The containers 500 can be independently inserted into and removed from each sleeve 200 as described above. The sleeves allow containers lower down in the rack to be removed without jeopardizing the stability of the containers above.

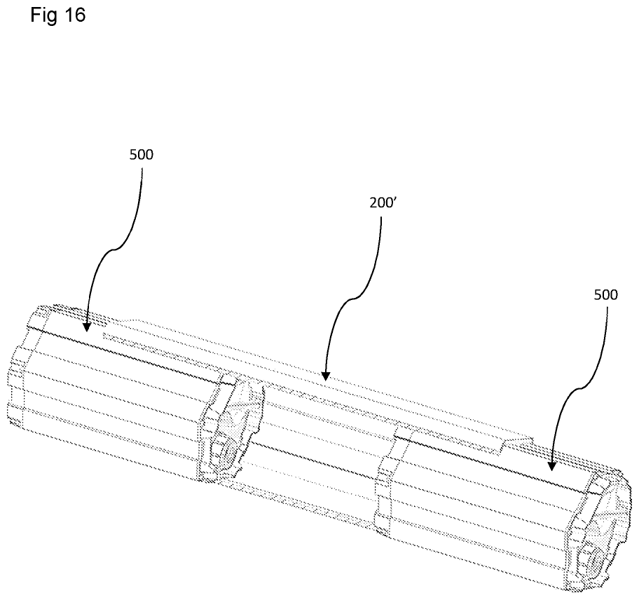

Referring now to FIG. 16, a second embodiment of the container sleeve 200′ is shown. The second embodiment is substantially similar to the first embodiment of sleeve, but this sleeve 200′ has a length approximately twice that of the containers 500. Two containers 500 are shown inserted in the sleeve 200′. This allows at least partial insertion of a container into the sleeve which already holds a container, allowing the second container to displace the first (either by physically abutting it or displacing it as air between the containers compresses as one container approaches the other).

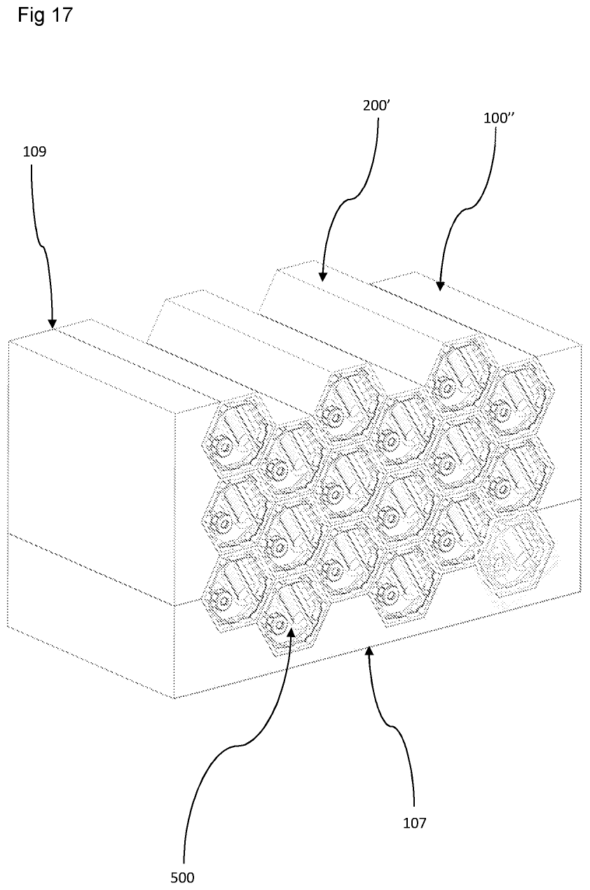

FIG. 17 shows another embodiment of a rack 100″. The rack 100″ is substantially similar to that of the first rack embodiment except that the distance between the front 107 and rear 109 is longer, to correspond to the longer sleeves 200′. In other words, the rack 100″ has a distance between the front 107 and rear 109 about twice (or more) that of the length of the containers 500. The sleeves 200′ are shown stacked inside the rack 100″ and can be inserted/removed in a similar manner to that previously described. It will be appreciated again that the rack may be sized to receive any desired number of containers and corresponding sleeves.

It will be appreciated that whilst the above embodiments are primarily described in relation to container pallets and container racks, equivalent embodiments are envisaged where the containers are battery cells and the container pallets are battery cell frameworks for aligning and engaging those battery cells. The container racks may in those embodiments be considered to be part of a battery casing or sheath or other battery structure, for example. In view of the similar structures of the framework and rack to those already described, these embodiments have not been described again, but the skilled person will appreciate that the same disclosure applies. Suitable electrical connections may be provided as needed to enable electrical power supply by the cells in the framework(s) and/or rack.

The embodiments described above are provided by way of example only, and various changes and modifications will be apparent to persons skilled in the art without departing from the scope of the present invention as defined by the appended claims.

1-27. (canceled)

28. A container pallet or battery cell framework comprising a lattice of walled cells for receiving and/or supporting a plurality of tessellatable containers in a close packed arrangement where side walls of the containers contact each other, in which each walled cell has a profile of or approximating a polygon that is tessellatable with itself or one or more other polygons, and one of:
each walled cell includes a lower side wall and an upper side wall, and the upper side wall is inset from the lower side wall in a direction towards a central axis of the walled cell; or
each walled cell includes a container receiving surface and a lower side wall extending away from the container receiving surface, each walled cell having a central axis, and at least one retaining lip is provided around a periphery of the container pallet or battery cell framework.

29. A container pallet or battery cell framework as claimed in claim 28, in which the upper side wall is angled inwards towards the central axis.

30. A container pallet or battery cell framework as claimed in claim 28, in which the walled cells are arranged in a horizontal plane.

31. A container pallet or battery cell framework as claimed in claim 28, in which the lower side wall and where provided the upper side wall define an aperture through the walled cell.

32. A container pallet or battery cell framework as claimed in claim 28, in which the lower side wall of at least some of the walled cells include engagement elements for engagement to one or more container pallets or battery cell frameworks and/or to one or more container pallet modules or battery cell framework modules.

33. A container pallet or battery cell framework as claimed in claim 28, comprising one or more sensors for sensing a weight of one or more of the containers above the one or more sensors.

34. A container storage system or battery comprising:
a rack for a plurality of containers in a tessellated or pseudo-tessellated arrangement, the rack comprising a base, a first side wall extending from the base, a second side wall extending from the base, the second side wall opposing the first side wall, a front, and a rear opposing the front, in which the first side wall includes a first corrugated face opposing the second side wall, and/or the second side wall includes a second corrugated face opposing the first side wall, and the base includes a base face extending between the first and second side walls from at or adjacent to the first and/or second corrugated faces, in which the base face and the or each corrugated face together define a surface profile for conforming to at least some sides of the tessellated or pseudo-tessellated arrangement of containers, in which a cross-section of the surface profile remains substantially identical or constant in a direction extending from the front to the rear of the rack for conforming to the arrangement of containers, and one of:
a) a plurality of containers disposed in the rack in a tessellated or pseudo-tessellated arrangement, each container being removable from the rack independently of other containers;
b) a plurality of containers disposed in the rack in a tessellated or pseudo-tessellated arrangement, and first and/or second container pallets or battery cell frameworks each as claimed in claim 1 at the front and/or rear of the rack respectively; and
c) a plurality of containers disposed in the rack in a tessellated or pseudo-tessellated arrangement, and first and/or second container pallets or battery cell frameworks at the front and/or rear of the rack respectively, each of the first and/or second container pallets or battery cell frameworks being a modular container pallet or modular battery cell framework for receiving and/or supporting the plurality of containers in a close packed arrangement where side walls of the containers contact each other, comprising a plurality of container pallet modules or battery cell framework modules, connected together in a tessellated arrangement or lattice, each container pallet module or battery cell framework module comprising:
a walled cell having a profile of or approximating a polygon that is tessellatable with itself or one or more other polygons, the walled cell including a lower side wall and upper side wall, in which the upper side wall is inset from the lower side wall in a direction towards a central axis of the walled cell, and the module includes side wall connection means for allowing connection of the module to at least one additional module.

35. A method of using a container storage system or battery as claimed in claim 34, the method comprising at least one of:
removing one or more of the containers from the rack;
inserting one or more replacement containers into the rack or into vacancies in the rack; and
displacing one of the plurality of tessellated or pseudo-tessellated containers from the rack by inserting a second container into the rack.

36. A container pallet module or battery cell framework module for tessellation and assembly with one or more other modules into a container pallet or battery cell framework, the module comprising a walled cell having a profile of or approximating a polygon that is tessellatable with itself or one or more other polygons, the walled cell including a lower side wall and upper side wall, in which the upper side wall is inset from the lower side wall in a direction towards a central axis of the walled cell, and the module includes side wall connection means for allowing connection of the module to at least one additional module.

37. A container pallet module or battery cell framework module as claimed in claim 36, in which the lower side wall and upper side wall together define an aperture through the walled cell.

38. A container pallet module or battery cell framework module as claimed in claim 36, in which a foot or a plurality of feet extend downwards from the lower side wall for supporting the lower side wall in a raised position spaced from an adjacent wall or ground.

39. A container pallet module or battery cell framework module as claimed in claim 36, in which the side wall connection means includes engagement elements on the lower side wall for engagement to one or more container pallet modules or battery cell framework modules and/or to one or more container pallets or battery cell frameworks.

40. A container pallet module or battery cell framework module as claimed in claim 39, in which the engagement elements include protrusions and/or recesses arranged along the lower side wall in a direction parallel to the central axis.

41. A modular container pallet or modular battery cell framework for receiving and/or supporting a plurality of tessellatable containers in a close packed arrangement where side walls of the containers contact each other, comprising a plurality of container pallet modules or battery cell framework modules each as claimed in claim 36, connected together in a tessellated arrangement or lattice.

42. A method of assembling a container pallet or battery cell framework for a plurality of tessellated containers, the steps comprising:
providing a plurality of container pallet modules or battery cell framework modules as claimed in claim 3; and
connecting or securing the modules together.

43. A rack for a plurality of containers in a tessellated or pseudo-tessellated arrangement, comprising a base, a first side wall extending from the base, a second side wall extending from the base, the second side wall opposing the first side wall, a front, and a rear opposing the front, in which
the first side wall includes a first corrugated face opposing the second side wall, and/or the second side wall includes a second corrugated face opposing the first side wall, and
the base includes a base face extending between the first and second side walls from at or adjacent to the first and/or second corrugated faces, in which the base face and each corrugated face together define a surface profile for conforming to at least some sides of the tessellated or pseudo-tessellated arrangement of containers, in which a cross-section of the surface profile remains substantially identical or constant in a direction extending from the front to the rear of the rack for conforming to the arrangement of containers.

44. A rack as claimed in claim 43, comprising one or both of:
the base face is a corrugated face; and
each corrugated face includes one or more elongate grooves and/or elongate protrusions for complementing corresponding portions on sides of the containers.

45. A rack as claimed in claim 43, including a plurality of container sleeves for each receiving one of the plurality of containers, and at least one of:
the container sleeves being provided in a tessellated arrangement or lattice in the rack; and
lubricant is provided on one or more internal surfaces of one or more of the container sleeves for facilitating ingress and/or egress of a container.

46. A method of packing or securing a plurality of tessellatable containers using at least two container pallets or battery cell frameworks, each container pallet or battery cell framework including a lattice of cells arranged in a plane, the method comprising the steps of:
locating a bottom end of each container in the plurality of containers to a topside of a respective cell of a first container pallet or battery cell framework; and
locating undersides of cells of a second container pallet or battery cell framework to respective top ends of the plurality of containers, to sandwich the plurality of containers between the container pallets or battery cell frameworks.

47. A method as claimed in claim 46, further comprising packing or securing a second plurality of containers using a third container pallet or battery cell framework which has a lattice of cells arranged in a plane, including the steps of:
locating a bottom end of each container of the second plurality of containers to a topside of a respective cell of the second container pallet or battery cell framework; and
locating undersides of cells of the third container pallet or battery cell framework to respective top ends of each of the second plurality of containers, to sandwich the second plurality of containers between the second and third container pallets or battery cell frameworks.
